(19) United States
(12) Patent Application Publication
(10) Pub. No.: US 2010/0114422 A1
(43) Pub. Date: May 6, 2010

(54) CONTROL DEVICE FOR VEHICLES

(76) Inventor: Lothar Weichenberger, Klingmoos (DE)

Correspondence Address: Brinks Hofer Gilson & Lione/Ann Arbor, 524 South Main Street, Suite 200, Ann Arbor, MI, 48104, US

(21) Appl. No.: 12/596,697

(22) PCT Filed: Apr. 17, 2008
(86) PCT No.: PCT/EP08/03103

§ 371 Date: Oct. 20, 2009

(30) Foreign Application Priority Data
Apr. 20, 2007 (DE) 10 2007 018 777.9

(51) Int. Cl. G06F 7/00

(52) U.S. Cl. 701/29

(57) ABSTRACT

The present invention relates to a control device for vehicles, in particular for the control of vehicle safety devices, with at least two control means, which each communicate with at least one common operating means, wherein the control means are connected to a monitoring means, which monitors the communication of each control means with the common operating means and with an operating means which is directly connected to another control means.

### CROSS REFERENCE TO RELATED APPLICATIONS

This application claims priority to DE 10 2007 018777.9 filed Apr. 20, 2007 and PCT/EP2008/003103 filed Apr. 17, 2008.

### FIELD OF INVENTION

The invention relates to a control device for vehicles and in particular for the control of vehicle safety devices.

### BACKGROUND OF INVENTION

In the area of vehicle electronics, control devices are used for measurement, control and regulation tasks. The steps required to perform these tasks are typically described in programs or operational sequences and are chiefly executed on a processor. Specific measures have to be provided for protection against systematic and spontaneous faulty behavior, depending on the safety requirements of the system. For this purpose, it is known to use monitoring computers for safety-critical systems in vehicles, such as for example electronic braking systems, electronic stability programs and electrohydraulic brakes. These so-called electronic controllers or control devices already today have physical and/or functional fallback levels according to variants of embodiment.

Such a hydraulic fall-back level, as is known, is implemented for example by the fact that, in a locking-protected braking system, the electronic ABS controller is switched off in the case of a fault. The hydraulic valves, which are de-energized when the controller is switched off, are designed such that normal braking can continue to take place without the anti-locking system.

An emergency operation or a restricted operation can thus be provided in the event of failure of the system or parts of the system. A functional fall-back level can also be created in a similar way. If, for example, a complex higher order software function, such as an electronic stability program is faulty and shuts down, the software of a lower order, for example an anti-locking system, continues to be operational.

The use of reliable electronic hardware for controlling and regulating vehicle functions in vehicles is constantly increasing. Particular attention is paid to high failure safety and a fault-tolerant design of the electronic devices. In WO 03/050624 A1 a fault-tolerant electronic control device is described, the availability and reliability of which with respect to the microprocessor system is better than is the case with previously known microprocessor designs.

For this purpose, a multi-core redundant monitoring computer system is provided, wherein at least two monitoring computers are connected to one another. The latter are provided, apart from with a computer core, in each case with partially or fully redundant peripheral elements and partially and fully redundant memory elements and are integrated on a common chip carrier or a common chip. At least two monitoring computers are connected to at least one common first arbitration unit, which monitors the monitoring computers for a malfunction.

Similar safety mechanisms are known from DE 10 35 09 19 A1, which relates to a control device and an acceleration sensor, and from EP 0 728 635 B1, which relates to a control device for an occupant protection device.

These previously known systems, however, can have issues with their reliability.

Thus, for example, no protection against mutual influencing is provided in the case of access of two or more software processes to the periphery. Thus, it is possible from process A to cause a modification in the address space directly or indirectly in operating means B. This may be the consequence of spontaneous faults or systematic mis-implementations.

Furthermore, time-sharing operating systems are based on timer-controlled process calls. These process calls are caused by interrupts from the periphery. The access to this periphery can however take place from an arbitrary point and can therefore cause a faulty modification. In general, comprehensive protection is not provided against systematic or sporadic faults, especially software faults.

A system according to the prior art can be explained with the aid of FIG. 1. Here, two independent control means 4.1 and 4.2 are provided. They cooperate with a jointly used operating means 2. The access to the operating means by control means 4.1 is denoted by continuous operating-means access 2.1. The access of control means 4.2 to the jointly used operating means via permitted operating-means access 2.1 is represented in the same way. Apart from the access to the common operating means, control means 4.1 and 4.2 are each connected exclusively to an operating means 5.1 and an operating means 5.2 respectively. Here too, there is in each case a permitted operating-means access 2.1.

An inadmissible communication 4.3 between control means 4.1 and 4.2 exists on the one hand via the dashed connection lines. The direct accesses of control means 4.2 to operating means 5.1 used by control means 4.1 and conversely of control means 4.1 to operating means 5.2 used exclusively by control means 4.2 are also represented. Operating-means accesses 2.2 represented here are also inadmissible.

In this configuration, there is the problem that, in the event that the control means execute the processes simultaneously, the latter may mutually influence one another. An influence on or a change in control means 4.2 due to control means 4.1 takes place precisely when control means 4.2 changes the process execution as a result of the process and arrives at a different result. The influencing of a control means by another control means, i.e. the respective processes initiated by the latter, can be both intentional as well as unintentional. Intentional influencing of the control means during the execution of the processes arises for example due to communication and/or synchronization with one or more other processes.

Within the scope of the present application, the control means defined here contain for example processes, e.g. specific program runs. The memory map of the program, memories for the data, resources made available by the operating system and a processor are required to run the program. In the following, these operating means are regarded as belonging to the control means or the processes executed by them. One generally speaks here of a “program in execution”. Control means, through the processes initiated by them, are on the one hand action supports in a computer, and on the other hand objects to which process capacity (CPU capacity) is assigned. In the case of unintentional influencing, a control means is influenced in a manner such as was not intended by the specification and/or such as is not beneficial to the solution to the problem which the control means is intended to overcome. Such process results present a problem especially in the case of safety-relevant applications.

### SUMMARY OF THE INVENTION

In at least one embodiment of the present invention, a control device is provided where such systematic and/or spontaneous faulty behavior is reliably avoided.

In one embodiment, a control device has at least two control means with a monitoring means which can be used in vehicles and which is used in particular for controlling vehicle safety devices. For the at least two control means, which each communicate with at least one common independent operating means and/or with at least one operating means connected to the respective other control means, it is thus possible to monitor the communication of each control means with the independent operating means and with an operating means which is connected to another control means. Unintentional influences between the control means may thus be eliminated.

In another embodiment, the distinction between an intentional and unintentional influence is made by the monitoring means with the aid of a rule-set. A possible form of the rule-set is represented by a singly or multiply nested tabular structure, by which the monitoring means can determine the validity of the memory accesses of a process.

In one example, in order that the monitoring means can perform its task, it is preferably implemented partially or completely in hardware. It can be created as part of the microcontroller or as a functional unit in a separate component or in separate hardware (e.g. separate silicon units). If the monitoring means is not completely implemented in the hardware, it is supplemented in its functionality by a program and/or a data/parameter record, which is referred to here as a rule-set. In order to obtain a system that is not excessively complex, a plurality of single monitoring means can be used.

The rule-set can be designed variable, e.g., dynamic, or invariable, e.g., static, during the system running time. Static rule-sets are preferably filed in a non-volatile memory, such as for example a ROM, PROM or Flash ROM. Writable memories, such as RAM for example, are suitable for dynamic rule-sets. The initialization of a dynamic rule-set can take place through a static rule-set.

The control means can influence one another differently during the operation. An unintentional influence is usually caused by a coupling of two or more control means via one or more jointly used operating means. Operating means in the sense of the present invention are understood to mean resources which are connected in a communication process to the control means, such as for example arithmetic-logic units, registers, logics, memories or peripheral devices.

If an influence exerted between the control means is to be prevented during the communication, the monitoring means ensures that the operating means requiring a control means for its execution can be used exclusively by the latter, e.g. simultaneous use by another communication with another control means must be excluded prior to completion of the execution of the communication process with the control means.

An example of an embodiment of such a system comprises an integrated component as a monitoring means and a microcontroller. For this purpose, the microcontroller makes internal states (an address bus, a program counter or anything else) available to the monitoring-means component. With the aid of the rule-set, the monitoring means can recognize whether the active communication process of the control means (possibly detectable by the program counter) has the necessary authorization to access the operating means (detectable for example by the information on the address bus). In the case of a permissible access, the further functional execution is not affected. In the case of an error, an activation of the operating means not permissible for the control means is brought about for example by interruption of the program execution, by interruption of the address or data bus or by transcribing the program counter.

If the exclusive use of an operating means can in principle be transcribed or if the operating means is being used simultaneously by more than one process, the monitoring means organizes the access in dependence on the rule-set. It can for example continue to permit alternately the exclusive access of different control means which are allowed to use the operating means.

If the operating means intended to be controlled by the various control means possesses a state in which the communication with the control means can be changed, the monitoring means must preferably ensure that the changes of state are not unintentionally transmitted by the communication to other control means. In the same sense, it is also expedient if the monitoring means safeguards the change of state brought about by the control means when a change is made to another control means and restores the same when the communication from another control means is changed back to the communication with the first control means. For example, the monitoring means can store the current configuration of an interface to which two control means have joint access during a change between the first and the second control means. If the communication again changes to the first control means, the stored configuration is again made available, so that any changes of state of the configuration made by the second control means have no influence on the first control means. When a change of the communication takes place, therefore, the monitoring means can make available the state of the operating means required at the time by a control means and left behind in the last communication.

In addition, the monitoring means can perform the task of a general access monitor. With this kind of access monitoring, it is not intended solely to prevent the unintentional influencing of the communication with a control means, but rather that the access of specific control means to specific operating means be blocked in general by the monitoring means. A communication for the operation of the vehicle diagnostic interface may, for example, not be able to initiate a safety-critical full brake application due to faulty behavior.

A possible implementation of the described properties is preferably achieved by the virtualization of the operating means. An operating means that has been used for the virtualization will be referred to below as a virtualized operating means. Operating means which arise through the process of virtualization of an operating means are referred to as virtual operating means. All mechanisms already described can also be mapped onto the virtual operating means. The virtualization can also extend to operating means in separate hardware or in a separate component (e.g. separate silicon units).

By means of the virtualization as previously described, actually existing operating means, one or more virtual operating means are produced by the monitoring means. The virtual operating means preferably has the same or similar properties and exhibits the same or similar behavior as the virtualized operating means from which they arise. In this case, the virtualized operating means should be used by the control means solely via the monitoring means. Instead, the virtual operating means are then available to the processes. The virtualization can also bring together a plurality of operating means in one virtual operating means.

The virtual operating means can thereby additionally gain properties and modes of behavior with respect to the virtualized operating means and vice versa. For example, mention may be made here of the implementation of data compression in actually existing operating means or a test summation in virtual operating means.

A possible application of virtual operating means can consist in implementing a communication interface (e.g. CAN interface) with external participants. Actual operating means, for example timers (for transmitted timing information), input and output terminals (for the data write and read function) or also units for the check summation calculation can be combined and controlled in a virtual operating means. The process controlling the virtual operating means does not however know the operating means behind the latter, nor can it control it. It treats the virtual communication interface as though it were actually implemented for the special application and ideally implemented for the process (e.g. as a CAN interface).

State changes which are carried out by a control means to a virtual operating means should therefore no longer be transmitted unintentionally to another operating means. At the same time, the state of the operating means should be able to be preserved over a process change. This is solved by the monitoring means, which makes available the virtual operating means and carries out the transformation of the appropriate properties and modes of behavior of the virtual operating means to the virtualized and/or actually existing operating means. An abstraction of the actually existing operating means can also take place here and, for example, the complexities of the operation of the virtual operating means for the processes can thereby be reduced.

The monitoring means can support or completely map the safety-directed properties of the system. Various strategies can be derived depending on the form of the system availability and/or failure safety. Safety-directed signifies the capability of the system to remain in a secure system state when specific faults or failure states occur, or to transfer directly into such a system state. For this purpose, the monitoring means can obtain the corresponding reaction instruction via a rule-set in the general and/or special case of a fault. For example, a predetermined process can be triggered in special fault cases.

Advantageously, each of at least two control means is also directly connected to an operating means and communicates with the latter without monitoring by the monitoring means. Furthermore, a control means can also communicate directly with a plurality of operating means. The communication of a control means with operating means to which another control means is directly connected is, however, advantageously monitored by the monitoring means. According to one embodiment of the invention, secure areas thus arise which are externally protected by the monitoring means against undesired influencing by other control means. Internally, however, the control means can freely communicate with the operating means in these protected areas, so that the complexity of the monitoring means can be reduced.

Furthermore, the monitoring means advantageously restricts or completely prevents the communication of the control means with operating means which are directly connected to another control means. For example, provision can be made such that control means, which are outside a secure area or in another secure area, cannot change the state of the operating means in a secure area, but can solely read out this state. Undesired influencing is thereby reliably avoided.

According to one embodiment of the invention, provision can advantageously be made such that the control means are processes or processors. For example, a plurality of processes are provided which access a common operating means, for example a jointly used memory area, wherein the monitoring means monitors the communication of the processes with these common operating means, e.g. the memory area, and for example permits individual processes to execute only writing and/or reading. Furthermore, individual processes can fully access certain operating means, such as for example memory areas or peripheral devices, without monitoring by the monitoring means. The accessing of other processes to these operating means, however, is monitored by the monitoring means and if need be is restricted or completely prevented.

Alternatively, the control means can also be microcontrollers or microcomputers. The control means then ensure that individual microcontrollers or microcomputers can only access common operating means in a monitored manner or that operating means such as peripheral devices or memory areas controlled directly by individual microcontrollers or microcomputers can be controlled only in a monitored manner or cannot be controlled at all by other microcontrollers or microcomputers.

Furthermore, the operating means can advantageously be memory areas and/or peripheral devices. It is thus ensured by the monitoring means that undesired influencing does not occur due to the access of the control means to the memory areas and/or peripheral devices. For example, the monitoring means monitors the access to a jointly used memory area and, for example, permits individual control means only to read out data or only to store data. Furthermore, the monitoring means can restrict or completely block the communication of a peripheral device, such as an external interface for example, with individual safety-relevant operating or control means.

Furthermore, a control means and one or more operating means directly connected thereto can advantageously form a virtual operating means, wherein the monitoring means allows a communication of the other control means solely with the virtual operating means. Regarding the communication with other control means, therefore, the first control means and the operating means directly connected thereto are merged together to form a virtual operating means, so that the other control means can no longer access the operating means individually.

Protection is also provided for at least one embodiment of the invention, which is independent of at least one other embodiment of the control system. The present invention therefore may comprise a control system for vehicles, in particular for the control of vehicle safety devices, with at least one control means which, together with one or more operating means directly connected to the control means, forms a virtual operating means. A monitoring means is provided which permits a communication of other control means solely with the virtual operating means.

The virtual operating means may be advantageously implemented by software. In particular, the control means, which together with the actual operating means connected directly thereto forms the virtual operating means, is a process which is implemented by the software and which simulates the virtual operating means. Thus, for example, a plurality of virtual operating means can be simulated on the same microcontroller or microcomputer. Alternatively, the control means can also denote a microcontroller or microcomputer on which software runs which simulates a virtual operating means. A plurality of virtual operating means can advantageously be simulated by the same actual operating means.

Further objects, features, and advantages of the present invention will become apparent from consideration of the following description and appended claims when taken in conjunction with the accompanying drawings.

### BRIEF DESCRIPTION OF THE DRAWINGS

FIG. 1 shows a system overview according to the prior art;

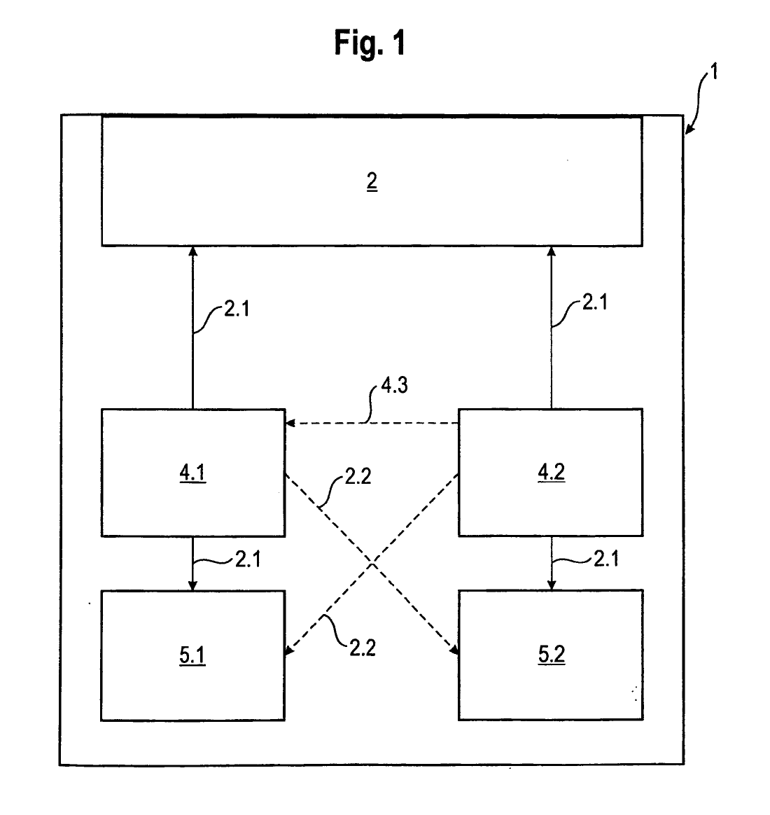

FIG. 2 shows a system overview of a first example of an embodiment of the solution according to the invention with two control means;

FIG. 3 shows a system overview of a second example of an embodiment of the present invention;

FIG. 4 shows a system overview of a third example of an embodiment of the present invention;

FIG. 5 shows the relationship between the actually existing operating means and the virtual operating means; and

FIG. 6 shows a system overview of a first example of another embodiment of the virtualization of operating means according to the invention.

### DETAILED DESCRIPTION OF THE INVENTION

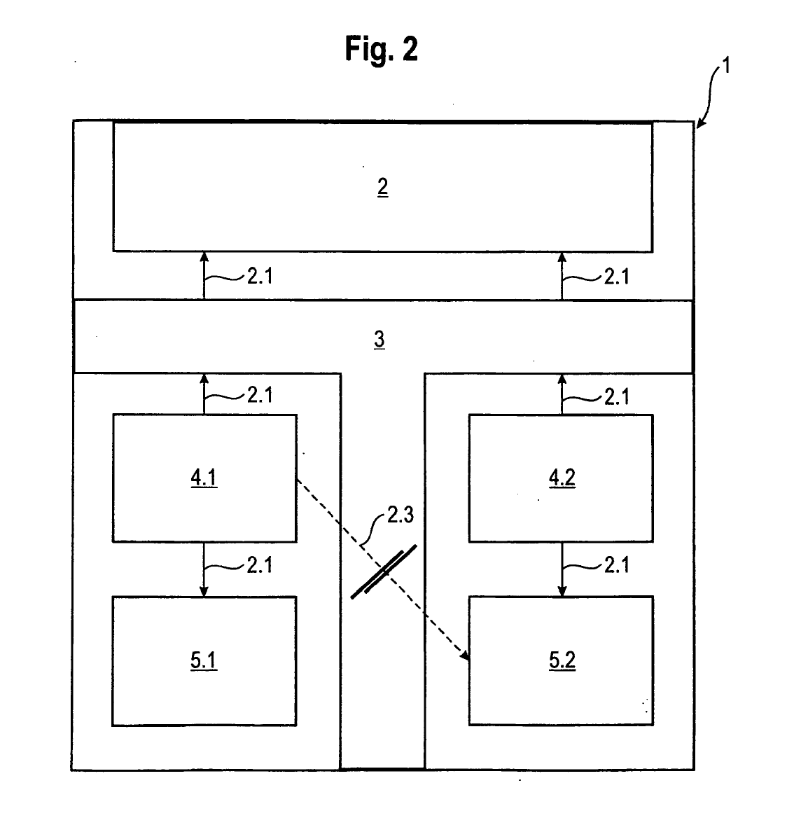

FIG. 2 shows the system overview of a first embodiment of the present invention. A safety system 1 with two control means 4.1 and 4.2 is provided in this example. The latter communicate directly with operating means 5.1 and 5.2 used exclusively by them. The further communication takes place via monitoring means 3, as is shown with the aid of communication routes 2.1. The access to the jointly used operating means takes place exclusively via monitoring means 3 or is monitored and, if need be, prevented by the latter. The access to exclusively used operating means 5.1 and 5.2 by the respective control means is permitted at all times and is not monitored specifically by monitoring means 3. An inadmissible access of a control means 4.1 directly to operating means 5.2 used exclusively by control means 4.2 is prevented (see prevented operating-means access 2.3).

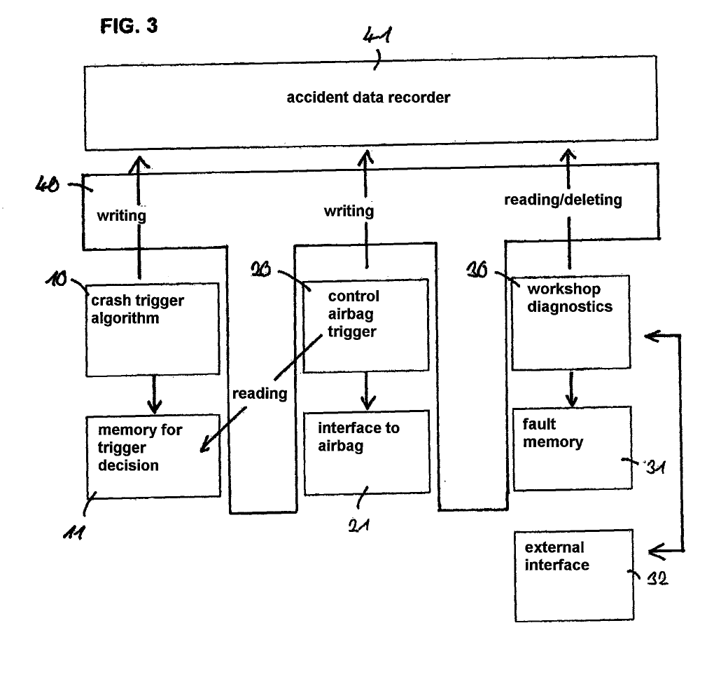

FIG. 3 shows a second embodiment of a control device according to the invention, which controls a single vehicle safety device, such as for example an airbag. The individual control means are processes which take place within the control and which access individual operating means and control the latter. The operating means are both memory areas as well as interfaces to peripheral devices.

Three control means are shown, crash trigger algorithm 10, control 20 for the airbag trigger and workshop diagnostics control 30. The individual control means each comprise operating means to which they are directly connected, so that monitoring means 40 does not monitor the communication with these operating means. The individual control means therefore each have full access to these operating means directly connected to them. The access of a control means to operating means connected directly to another control means, on the other hand, is monitored by monitoring means 40 and, if need be, restricted or completely prevented.

Crash trigger algorithm 10 is directly connected to a memory for trigger decision 11 and has full access to the latter. The communication of control 20 for the airbag trigger with the memory for trigger decision 11, on the other hand, is monitored by monitoring means 40, wherein the monitoring means ensures that control 20 for the airbag trigger can only read out the memory for trigger decision 11, but cannot change it. Undesired influencing of crash trigger algorithm 10 by control 20 of the airbag trigger is thus prevented.

Control 20 for the airbag trigger, for its part, is directly connected to interface 21 for the airbag and can thus control the latter directly without monitoring by monitoring means 40. Workshop diagnostics 30 is directly connected both to fault memory 31 and to an external interface 32, so that the communication between these components takes place without intervention by monitoring means 40. Workshop diagnostics 30 can thus control external interface 32 or be controlled via external interface 32. An access of workshop diagnostics 30 to the operating means of control 20 for the airbag trigger or crash trigger algorithm 10, however, is prevented by the monitoring means, as is an access of crash trigger algorithm 10 to the operating means of control 20 for the airbag trigger as well as to workshop diagnostics 30. Undesired influencing of the individual processes amongst one another can thus be prevented.

However, a common operating means is also provided in the form of an accident data recorder 41, with which all control means can communicate at least in restricted form via monitoring means 40. The access of crash trigger algorithm 10 to accident data recorder 41 is restricted by monitoring means 40 to writing, as is the access of control 20 for the airbag trigger. Workshop diagnostics 30, on the other hand, can read and delete the data from accident data recorder 41. Monitoring means 40 thus ensures that the communication of the individual processes with common operating means 41 takes place without undesired influencing. Control processes taking place on the control device according to the invention will now be described by way of example: e.g. crash trigger algorithm 10 detects a crash situation and directly accesses the memory for trigger decision 11 in order to file a positive trigger decision there. At the same time, it writes the data upon which the trigger decision is based in accident data recorder 41, wherein this communication is monitored by monitoring means 40 to ensure that no data already present in accident data recorder 41 is changed or deleted. Control 20 for the airbag trigger accesses the memory for trigger decision 11 via monitoring means 40 and reads out this result, monitoring means 40 restricting the access to reading. Control 20 for the airbag trigger communicates directly with the interface to airbag 21 and thus triggers the airbag.

The communication between the individual areas from control means with operating means directly connected thereto is thus monitored via monitoring means 40, in order in this way to provide for the safety of the communication. Monitoring of the communication between crash trigger algorithm 10 and the memory for trigger decision 11 and the communication between control 20 and the interface to airbag 21 is not provided for, and this reduces the complexity of the monitoring means.

Workshop diagnostics 30 can read out and delete data from accident data recorder 41 via monitoring means 40, and also file fault reports in fault memory 31 directly connected to workshop diagnostics 30. The corresponding data can then be read out via external interface 32. A restriction of the communication between workshop diagnostics 30, fault memory 31 and external interface 32 is however not necessary, so that the complexity of monitoring means 40 can be reduced.

The second embodiment thus concerns a control device, wherein individual processes form the control means, which access memory areas or peripheral devices, where the monitoring means, which also represent processes, monitors the communication.

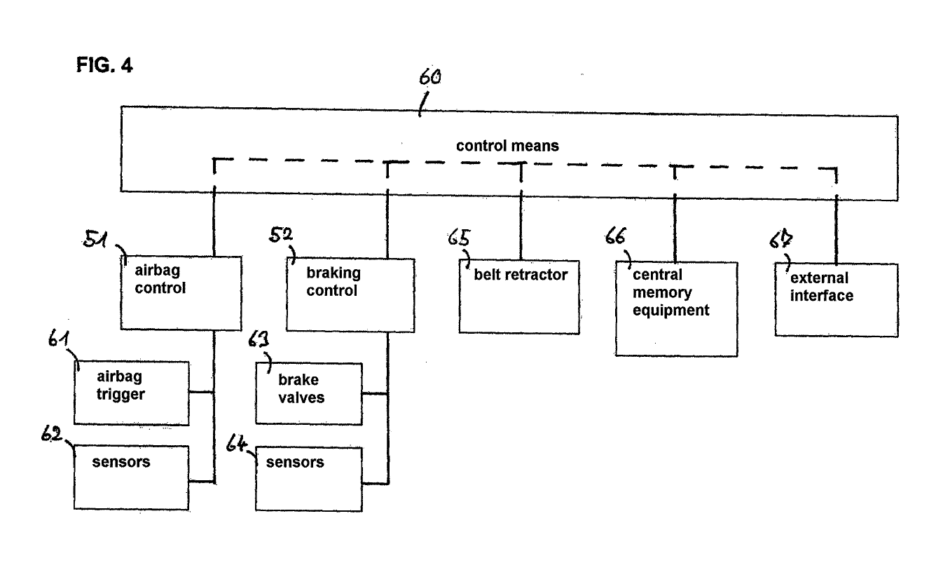

FIG. 4 shows a third embodiment of the present invention, where the individual control means control different vehicle safety devices. The control means can be designed in each case as individual microcontrollers and/or microprocessors, but can also be implemented as software on a common microcomputer. This embodiment comprises an airbag control 51 and a braking control 52 as control means. Airbag control 51 communicates directly with airbag trigger 61 and with sensors 62 and without monitoring by monitoring means 60. Braking control 52, for its part, communicates directly with brake valves 63 and sensors 64 and without monitoring by monitoring means.

The communication between the control means and such operating means, which are directly connected to the respective other control means, takes place on the contrary via with monitoring means 60, so that undesired cross-influencing between airbag control 51 and braking control 52 is reliably avoided here.

Furthermore, a belt retractor 65, a central memory 66 for the equipment and an external interface 67 are provided as common operating means of airbag control 51 and braking control 52, with which both control means can communicate solely via monitoring means 60. Apart from triggering the airbag via airbag trigger 61 when a crash situation is detected, airbag control 51 can thus also retract the belt via belt retractor 65. When a full brake application is detected, for example, braking system 52 can also tighten the belt via belt retractor 65. In order not to permit any negative cross-influencing here, the communication between airbag control 51 and belt retractor 65 and respectively between braking system 52 and belt retractor 65 takes place via monitoring means 60 according to the invention. The monitoring means can for example assign preferences to individual commands or individual control means, so that an ordered access to belt retractor 65 takes place.

Furthermore, monitoring means 60 can restrict access of airbag control 51 and braking control 52 to central memory 66 for the equipment, for example, solely to a read access. On the other hand, monitoring means 60 can clear the access of external interface 67 to central memory 66 and thus enable updating. The access of external interface 67 to belt retractor 65 as well as the operating means of airbag control 51 and braking control 52, on the other hand, is completely prevented.

The communication of the individual control means with the operating means takes place in the third embodiment via a bus system, where airbag control 51 and braking control 52 communicate via a common bus with the operating means directly connected respectively to them. In the bus system, with which airbag control 51 and braking control 52 communicate with one another and with common operating means, monitoring means 60 which duly monitors the communication is on the other hand integrated. Either a central monitoring means 60 can be provided, with which all the components are connected via buses, or separate monitoring-means elements at different points of the bus system.

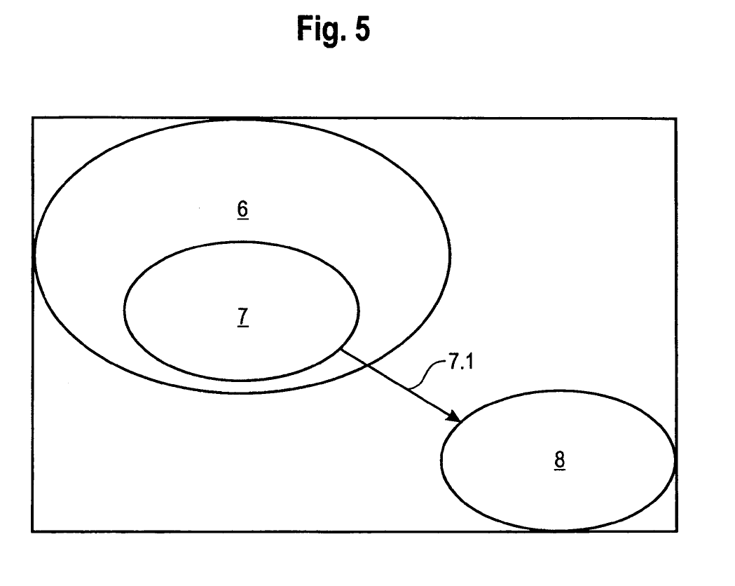

FIG. 5 shows the interrelationships between actually existing operating means 6 and a virtual operating means 8. In this regard, a subset 7 of actually existing operating means 6 is mapped by a virtualization 7.1 to a set of virtual operating means.

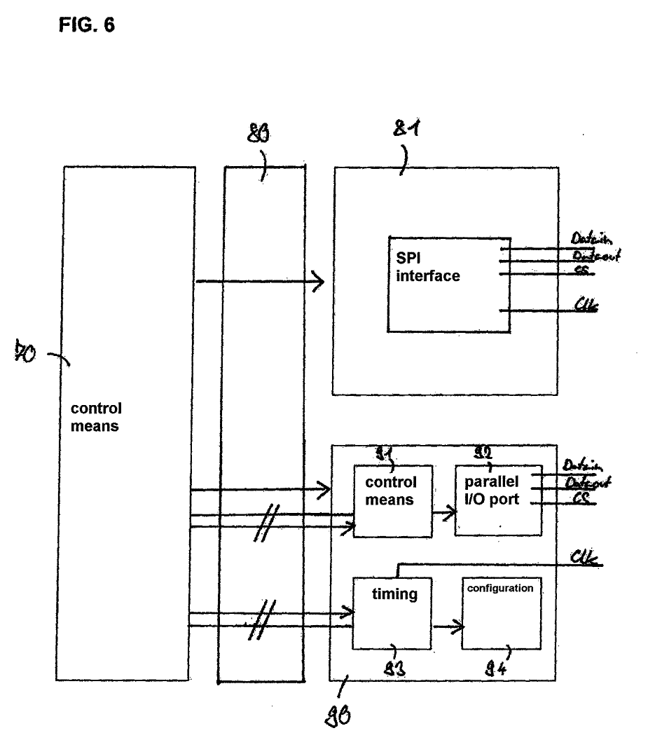

FIG. 6 shows the virtualization of an operating means in an example embodiment. The example embodiment shows a control means 70, which on the one hand can access a hardware-implemented SPI interface 81, which thus represents an actually existing operating means. The communication of control means 70 with SPI interface 81 is monitored, if need be, by monitoring means 80.

According to the invention, moreover, a virtual SPI interface 90 is represented, which is formed by actual control and operating means, in particular by a microcontroller 91, a parallel I/O port 92, a timing generator 93 and a configuration memory 94. Microcontroller 91 can directly access port 92, timing generator 93 and configuration memory 94, without this communication being monitored by monitoring means 80. Monitoring means 80, however, prevents a direct access of control means 70 to the actual control and operating means and permit only the communication of control means 70 with virtual interface 90, which is advantageously made available via software running on microcontroller 91. In this way, undesired accesses of control means 70 to actual components are prevented and a virtual interface is made available, which can be controlled in just the same way as actual SPI interface 81. A plurality of virtual operating means can also be generated with the same actual control and operating means. Thus, for example, a plurality of virtual SPI interfaces can be made available by the same actual operating and control means.

As a person skilled in the art will readily appreciate, the above description is meant as an illustration of implementation of the principles of this invention. This description is not intended to limit the scope or application of this invention in that the invention is susceptible to modification, variation and change, without departing from the spirit of this invention, as defined in the following claims.

1. A safety device for control of vehicle safety devices of a vehicle, the safety device comprising: at least two control means which each communicate with at least one common operating means for the control of the vehicle safety devices, wherein
the at least two control means are each directly connected to a corresponding second operating means, and the at least two control means are connected to a monitoring means, which monitors the communication of each of the at least two control means with the common operating means and with the corresponding second operating means.

2. The safety device according to claim 1, wherein the second operating means are arithmetic-logic units, registers, logic components, memories or peripheral devices.

3. The safety device according to claim 1, wherein the monitoring means contains a rule-set by means of which it is possible to distinguish between intentional and unintentional influencing of the communication.

4. The safety device according to claim 3, wherein the monitoring means can transfer the system to be controlled into a safe state when a rule of the rule-set is broken.

5. The safety device according to claim 1, wherein the monitoring means is designed at least partially as hardware.

6. The safety device according to claim 1, wherein the monitoring means monitors the second operating means as at least one of actual operating means and virtual operating means, wherein monitoring of the second operating means as the virtual operating means is after virtualization of the second operating means.

7. The safety device according to claim 1, wherein the monitoring means is implemented in separate hardware.

8. The safety device according to claim 6, wherein the virtual operating means are implemented in separate hardware.

9. The safety device according to claim 6, wherein the monitoring means safeguards the change of state of at least one of the actual and the virtual operating means brought about by a first control means when the communication is changed to another control means and restores the same when the communication from the another control means is changed back to the communication with the first control means.

10. The safety device according to claim 1, wherein each of the at least two control means communicates with the corresponding second operating means without monitoring by the monitoring means.

11. The safety device according to claim 1, wherein the monitoring means restricts or prevents the communication between one of the at least two control means and the corresponding second operating means which is directly connected to the other of the at least two control means.

12. The safety device according to claim 1, wherein the control means are processors.

13. The safety device according to claim 1, wherein the control means are microcontrollers or microcomputers.

14. The safety device according to claim 1, wherein the operating means are memory areas or peripheral devices.

15. The safety device according to claim 1, wherein one of the at least two control means and one or more of the second operating means directly connected thereto form a virtual operating means, wherein the monitoring means permits a communication of the other of the at least two control means with only the virtual operating means.

16. The safety device according claim 15, wherein the virtual operating means is implemented by software.
